(19) United States
(12) Patent Application Publication
(10) Pub. No.: US 2006/0171164 A1
(43) Pub. Date: Aug. 3, 2006

(54) Optical film structure, illlumination apparatus and liquid crystal display device

(76) Inventor: Akira Kida, Kawasaki-shi (JP)

Correspondence Address: 3M INNOVATIVE PROPERTIES COMPANY, PO BOX 33427, ST. PAUL, MN, 55133-3427, US

(21) Appl. No.: 10/542,163

(22) PCT Filed: Jan. 15, 2004
(86) PCT No.: PCT/US04/00976

§ 371 Date: Jul. 12, 2005

(30) Foreign Application Priority Data
Jan. 17, 2003 (JP) 2003-009775

(51) Int. Cl. F21V 7/04

(52) U.S. Cl. 362/608

(57) ABSTRACT

To provide an optical film structure useful in a liquid crystal display device and capable of using thin optical films without warp and distortion. An optical film structure comprises at least one optical film, at least four film fixing parts arranged at an outer peripheral portion of the optical film, a film tension controlling member fitted at one of the ends thereof to each of the film fixing parts in such a fashion as to be capable of pulling the optical film under tension while maintaining flatness of the optical film, and a film fixing frame to which the other end of the film tension controlling member is connected and which fixes the optical film.

This invention relates to an optical film structure, an illumination apparatus and a liquid crystal display device. More particularly, the invention relates to an optical film structure that can be advantageously used in a liquid crystal display device in combination with an illumination unit having at least one optical film, and an illumination apparatus and a liquid crystal display device each having such an optical film structure. In the liquid crystal display device according to the invention, an outer periphery of the optical film, in particular, is fitted to a fixing flame through a film tension controlling member including a flexible member such as a spring or rubber. Therefore, distortion of the optical film due to heat and aging can be absorbed, the surface can be kept flat and consequently, degradation of display performance of the liquid crystal display device can be prevented.

### BACKGROUND

A liquid crystal display device has features of a small thickness, a small weight and low power consumption. Therefore, it has widely been used as a display device in information processing apparatuses and video apparatuses. Examples of the application of the liquid crystal display device include displays for a cellular phone, a video camera, a digital camera, a personal computer, a television receiver, and other applications.

Liquid crystal display devices of various types are now available commercially. Generally, a liquid crystal display device includes optical elements having various characteristics such as an optical plate and an optical film in front of an illumination apparatus in order to efficiently transmit the rays of light from the illumination apparatus disposed at the back of the liquid crystal display device and to accomplish a brighter and more uniform display screen.

In a liquid crystal display device employing a perpendicular type backlight system an illumination apparatus is arranged on the back surface of a liquid crystal display panel. The light from the illumination apparatus which may for example include a plurality of fluorescent tubes embedded into a transparent resin is supplied to a diffusion plate and diffused rays of light transmitting through the diffusion plate are irradiated to the back surface of the liquid crystal display panel in order to provide a uniform luminance distribution. An acrylic resin plate containing fine SiO₂ particles and having a thickness of about 1.5 mm is used as the diffusion plate. When the plate is thin, a uniform luminance distribution cannot be obtained easily due to warp and undulation of the plate. As the scale of liquid crystal display devices has become greater in recent years, warp and undulation of the plate has become more likely to occur and the thickness of the diffusion plate itself has been increased to suppress such problems. On the other hand, the increase of the weight of the diffusion plate resulting from the increase of the thickness and the area of the plate has become another problem.

To avoid the problems of the optical plate such as the diffusion plate, the use of optical films, optical sheets, etc, in place of the optical plate has been proposed recently. For example, a liquid crystal display device using a so-called “luminance improving film” on the side of a light guide plate of a backlight to improve light emission luminance of the liquid crystal display panel is known. In this liquid crystal display device, a luminance improving film having a prismatic shape (prism film) is arranged on the light outgoing surface side of the guide plate to remarkably improve power consumption-luminance conversion efficiency. In such a device, a dot-like light diffusion material is generally printed on the surface of the guide plate opposite to the light output surface to obtain uniform light emission. Because this dot-like pattern results in bright spots, a light diffusion film is interposed between the luminance improving film and the guide plate so as to conceal the dot-like pattern and to eliminate the problem of non-uniform luminance.

A liquid crystal display device using a luminance improving film other than the prism film described above is also known. The liquid crystal display device uses a reflective polarizing film having a luminance improving effect. Although this reflective polarizing film can be used alone, it is preferred to use a prism film in combination to further improve the luminance improving effect.

The optical films such as the luminance improving film and the reflective polarizing film described above are important for the optical design of the liquid crystal display device. However, warp and distortion of the film has become more likely to occur in recent years due to the increase in the size of the liquid crystal display devices. To suppress these problems, the thickness of the optical film itself is increased or a thick sheet is bonded to the optical film. However, a new problem develops in that the attenuation ratio of transmitted light becomes higher with the increase of the thickness of the optical film and the luminance improving effect drops.

On the other hand, a liquid crystal display device having a backlight formed by stacking a plurality of light diffusion films is known, too. To solve the problem of non-uniform luminance, a method that increases the total thickness of the light diffusion film has generally been employed. Because the light transmission factor drops with the increase of the thickness and surface luminance drops consequently, a plurality of thin light diffusion films are stacked in this liquid crystal display device to improve the transmission factor and diffusion property of the light diffusion film.

Nonetheless, when this stacking method is employed, a problem arises in that the number of optical films increases and the assembly work of a group of optical films into the liquid crystal display device becomes complicated. A method requiring intense labor that bonds the optical films to the backlight main body with an adhesive or fixes them with screws is generally used to assemble the optical films.

Each optical film is commercially available with a protective film bonded to the optical film to protect the film surface from damage resulting from friction, and so forth. To assemble the optical films, the protective films must be peeled one by one, thereby further intensifying the labor. Furthermore, the problems of the occurrence of static electricity and disposal of the wastes occur, too.

In addition, when the light diffusion films are used under the stacked state as described above, the problem of the warp or distortion of the films is unavoidable.

### BRIEF DESCRIPTION OF THE DRAWINGS

FIG. 1 is a sectional view showing a liquid crystal display device according to a preferred embodiment of the invention.

FIG. 2 is a perspective view showing an illumination unit of the liquid crystal display device shown in FIG. 1.

FIG. 3 is a plan view showing an illumination apparatus according to a preferred embodiment of the invention.

FIG. 4 is a sectional view of the illumination apparatus taken along a line IV-IV in FIG. 3.

FIG. 5 is a sectional view showing a fixing method of a film tension controlling member in the illumination apparatus shown in FIG. 3.

FIG. 6 is a sectional view showing a modified example of the fixing method of the film tension controlling member shown in FIG. 5.

FIG. 7 is an enlarged sectional view showing an optical film structure according to a preferred embodiment of the invention in the proximity of the film tension controlling member.

FIG. 8 is an enlarged sectional view showing an optical film structure according to another preferred embodiment of the invention in the proximity of the film tension controlling member.

FIG. 9 is a plan view showing a fixing method of an optical film to a film fixing frame in the optical film structure according to the invention.

FIG. 10 is a plan view showing another fixing method of the optical film to the film fixing frame in the optical film structure according to the invention.

FIG. 11 is a plan view showing still another fixing method of the optical film to the film fixing frame in the optical film structure according to the invention.

FIG. 12 is a sectional view of the optical film structure taken along a line XII-XII in FIG. 11.

FIG. 13 is a sectional view showing a modified example of the optical film fixing method shown in FIG. 12.

FIG. 14 is a plan view showing another fixing method of the optical film to the film fixing frame in the optical film structure according to the invention.

FIG. 15 is a sectional view of the optical film structure taken along a line XV-XV in FIG. 14.

FIG. 16 is a plan view showing an application example of the optical film fixing method shown in FIGS. 14 and 15 to a corner.

### SUMMARY OF THE INVENTION

According to one aspect of the invention, there is provided an optical film structure disposed on a light transmission surface of an illumination unit, for modulating light emitted from the illumination unit and projecting modulated light, comprising at least one optical film; at least four optical film fixing parts disposed at an outer peripheral portion of the optical film; a film tension controlling member attached at one of the ends thereof to each of the film fixing parts in such a fashion as to be capable of pulling the optical film under tension while maintaining flatness of the optical film; and a film fixing frame for fixing the optical film connected to the other end of the film tension controlling member; wherein the optical film, the film tension controlling member and the film fixing frame are integrated with one another and are constituted into one component.

According to another aspect of the invention, there is provided an illumination apparatus comprising an illumination unit at least including at least one light source and a light transmission surface for guiding outward the rays of light from the light source; and an optical film structure according to the invention that is arranged on the light transmission surface of the illumination unit.

According to still another aspect of the invention, there is provided a liquid crystal display device comprising an illumination unit at least including at least one light source and a light transmission surface for guiding outward the rays of light from the light source;

an optical film structure according to the invention that is arranged on the light transmission surface of the illumination unit; and a liquid crystal display device arranged on the optical film structure.

### DETAILED DESCRIPTION

The preferred embodiments of the invention will be explained in detail. Note, however, that the invention is in no way limited to the following embodiments.

In the practice of the invention, a liquid crystal display device is not particularly limited so long as an optical film structure according to the invention is built in its illumination unit. Therefore, the liquid crystal display device according to the invention includes:

an illumination unit having at least one light source and an illumination unit having at least a light transmission surface for guiding the rays of light from the light source to outside;

an optical film structure according to the invention arranged on the light transmission surface of the illumination unit; and

a liquid crystal display unit arranged on the optical film structure.

The illumination unit and the liquid crystal display unit may be of the types that are well known in this technical field, respectively.

The liquid crystal display device can be classified into a transmission type liquid crystal device and a reflection type or semi-transmission type liquid crystal display device depending on an illumination system. These liquid crystal display devices can be used appropriately by making the most of the features of the respective types. Because the invention exhibits excellent operations and effects in an optical film structure used while built in the liquid crystal display device, the invention can suitably provide a transmission type, and relatively large, liquid crystal display device.

The transmission type liquid crystal display device includes a liquid crystal display unit having a pair of transparent substrates sandwiching a liquid crystal between them. An illumination apparatus, that is, a so-called “backlight illumination unit” as a back surface light source, is arranged at the back of the liquid crystal display unit. When the backlight is turned on in the liquid crystal display device of this type, images displayed on a liquid crystal panel can be observed from the front surface of the panel. A lamp such as a cold cathode fluorescent tube is used for the backlight. In this transmission type liquid crystal display device, the backlight the major proportion of power consumption. For, the backlight must be kept always turned ON. Therefore, the backlight has widely been used for displays of desk-top and notebook type personal computers to which power can be easily supplied.

Specifically, in the transmission type liquid crystal device using the backlight, the light emitted from the backlight disposed at the back of the liquid crystal display chip is generally passed through a polarizer and is linearly polarized so that display can be made by the light so polarized. Because ordinary backlight is non-polarized light, a polarizer is generally used to acquire linearly polarized light. However, light absorption of the polarizer used herein exceeds 50%. To supplement this absorption and to achieve a bright screen, it is necessary to increase luminance of the illumination apparatus. To satisfy the requirement for improving luminance, for example, a light source having increased light power may be used, but the problem of the increase of power consumption and exothermy develops afresh in this case. This problem is serious particularly in mobile apparatuses such as the notebook personal computers as explained above and counter-measures must be taken. For, the increase of power consumption shortens the battery life and the increase of exothermy results in the drop of reliability and service life.

Still another cause makes it difficult to increase luminance. To satisfy the requirements for saving power and space, the diameter of the lamp has been decreased and a wedge-shaped guide plate for reducing the thickness and the weight has been employed. According to the structure of the light guide of this kind, it is difficult to simultaneously increase luminance. Because shapes of components are small and complicated in the guide plate of this kind, another problem develops in that handling and assembly are difficult.

To solve the problem of the increase of luminance and other optical problems, the liquid crystal display device according to the invention uses one optical film on the front surface of the backlight illumination unit or in other words, on the back surface of the liquid crystal display unit, and fixes this optical film in the liquid crystal display device by use of a film fixing system comprising a combination of (1) film fixing parts, (2) a film tension controlling member and (3) a film fixing frame as will be explained later in detail.

The invention can particularly constitute an illumination apparatus by fitting at least one optical film under tension to an illumination unit by use of a specific film fixing system according to the invention. Therefore, the liquid crystal display device can provide the following remarkable effects, for example, as will be explained later in further detail.

(1) A film having a large luminance improving effect that has not been able to be used in the past for a large-scale liquid crystal display device can now be used and a film structure having a higher luminance improving effect can be accomplished.

(2) The film having a high luminance improving effect that has been used in the past separately for the large scale and for the medium scale can now be used irrespective of the size, and a film structure (combination of optical films) having higher freedom can be provided.

(3) Because a light diffusion film is used in place of the acrylic diffusion plate, a diffusion layer free from distortion in all sizes can be provided and the weight can also be reduced.

(4) Because a plurality of optical films can be united, post-steps can be simplified and rendered efficient, and a protective film can be eliminated, too.

In the practice of the invention, the optical film used for forming the optical film structure is not particularly limited but can be used arbitrarily in accordance with optical characteristics required in the illumination apparatus and in the liquid crystal display device according to the invention. In this instance, the optical film may be used either individually or in an arbitrary combination of two or more films. Suitable examples of the optical film, though not restrictive, include a film having light diffusion performance (hereinafter called “light diffusion film”), a film having light reflection performance (hereinafter called “light reflection film”), a film having a luminance improving effect (hereinafter called “luminance improving film”), a film having polarization performance (hereinafter called “polarization film”) and a film having two or more performances of these optical films in combination (hereinafter called “multifunctional film”).

Either one or two or more of these optical films in combination can be used as the optical film structure for the illumination unit of the liquid crystal display device, preferably between the backlight illumination unit and the liquid crystal display unit on the former, for example. Single layered structure (using one optical film):

When one optical film is used to constitute the optical film structure, it is possible to use the light diffusion film, the luminance improving film (such as a prism film), the polarization film (such as a reflection type polarization film) or a composite film or multifunctional optical film having two or more performances of these films.

When an illumination unit utilizing a light guide is used, for example, that is, when the light guide is conjointly used for the light diffusion surface of the illumination unit, the light diffusion film or a composite film of the light diffusion film with the luminance improving film can be used. A perpendicular type backlight illumination unit equipped with a guide plate formed of an acrylic diffusion plate on its light diffusion surface is a typical example of such an illumination unit. Incidentally, when the acrylic diffusion plate does not exist in this illumination unit, the optical film is limited to the light diffusion film or its composite film.

Two-Layered Structure (Using Two Optical Films):

When two optical films are used in combination to constitute the optical film structure, the optical film similar to that of the single layered structure described above can be used as the film on the illumination unit side. The film on the side of the liquid crystal display unit may be the light diffusion film, the luminance improving film (for example, a prism film), the polarization film (such as a reflection type polarization film) or its composite film.

Three-Layered Structure (Using Three Optical Films):

When three optical films are used in combination to constitute the optical film structure, the optical film similar to the one used in the single layered structure can be used as the film on the illumination unit side. The intermediate film may be the light diffusion film, the luminance improving film (for example, a prism film), the polarization film (for example, a reflection type polarization film) or its composite film. These films can also be used as the film on the side of the liquid crystal display unit. When the intermediate film uses the reflection type polarization film, however, the film on the side of the liquid crystal display unit uses the light diffusion film. The light diffusion film used in this case is limited to those light diffusion films that do not collapse (deflect) the phase of light deflected by the reflection type polarization film used as the intermediate film. For the same reason, the prism film that collapses the phase of deflected light cannot be used on the reflection type polarization film.

Multi-Layered Structure (Using Four or More Films):

Four or more optical films can be used in combination to constitute the optical film structure. Here, the combination of the films analogous to those described above can be applied up to the three-layered structure. The following illustrates examples of the combinations of the four-layered structures though they are in no way restrictive.

(1) The light diffusion film, the light diffusion film, the prism film and the prism film in order named from the illumination unit side.

(2) The light diffusion film, the prism film, the prism film and the light diffusion film in order named from the illumination unit side.

(3) The light diffusion film, the prism film, the prism film and the reflection type polarization film in order named from the illumination unit side.

(4) The light diffusion film, the prism film, the reflection type polarization film and the light diffusion film in order named from the illumination unit side.

Though the combination of the five or more layered structure is not herein illustrated, five or more optical films can be used in combination on the basis of the same concept as described above.

In the case of the perpendicular type backlight illumination unit not having the acrylic diffusion plate, it is possible to use the combination of the light diffusion film, the light diffusion film, the prism film and the reflection type polarization film in order named from the illumination unit side or the combination of the light diffusion film, the light diffusion film, the light diffusion film, the prism film and the reflection type polarization film in order named from the illumination unit side.

In the combinations described above, the composite film or the multifunctional film can be used, too. In the case of the perpendicular type illumination unit, the size is large. Therefore, it is possible to advantageously use a composite film obtained by providing diffusion property and rigidity to the reflection type polarization film (film obtained by bonding the optical diffusion films to both surfaces of the reflection type polarization film).

When two or more optical films are used in lamination or stacking, the optical films may be stacked with or without gaps among them. It is generally preferred to stack the optical films with small gaps among them and to fix them to a film fixing frame. Here, the gap among the films can be changed in a broad range depending on a desired optical system in the optical film structure but is generally within the range of about 0.3 to 2.0 mm and preferably within the range of about 0.5 to 1.0 mm.

Each of the optical films used in the practice of the invention will be further explained.

The light diffusion film is ordinarily a film having a diffusion surface treatment that applies mat processing or emboss processing to a polymer film. It is also possible to employ other diffusion surface treatment by applying sand blast processing or by arranging a plurality of fine protuberances on the surface. Further, the light diffusion surface can be formed by internally dispersing diffusion particles such as TiO₂.

The light diffusion film can be formed from compositions containing a polycarbonate resin, an acrylic resin, a polyester resin, an epoxy resin, a polyurethane resin, a polyamide resin, a polyolefin resin, a silicone resin (inclusive of modified silicone such as silicone polyurea) and so forth in accordance with various molding methods. Concrete examples of the light diffusion film include an optical diffusion film “Opals Series”, products of Keiwa Co.

The light diffusion film can be used at an arbitrary thickness depending on the object of use but should generally be selected in such a fashion as to reduce the thickness and the weight of the liquid crystal display device. Therefore, the thickness of the light diffusion film is generally within the range of about 5 to 1,000 μm, preferably within the range of about 5 to 500 μm and further preferably within the range of about 5 to 200 μm. The thickness of the light diffusion film is most preferably within the range of about 5 to 150 μm.

Luminance improving films that are generally used in this field of technology can be used as the luminance improving film. A typical luminance improving film is a luminance improving film having a prismatic shape (prism film). Concrete examples of the prism film that can be used in the practice of the invention include luminance improving films “BEFII Series”, “BEIII Series”, “RBEF Series” and “NBEF Series” (trade names), products of 3M Co.

The luminance improving film can be used at an arbitrary thickness, too, depending on the object of use. The thickness of the luminance improving film should be selected generally so as to reduce the size and the weight of the liquid crystal display device and is generally within the range of about 5 to 1,000 μm, preferably within the range of about 5 to 500 μm and further preferably within the rage of about 5 to 200 μm.

A film having a reflection type polarization property can be used for the luminance improving film. The reflection type polarization film is generally a polarization film that can transmit light in a vibration direction parallel to one in-plane axis (transmission axis) but can reflect other rays of light. In other words, this film transmits only the light component in the vibration direction parallel to the transmission axis described above among the rays of light incident into the polarization film and exhibits the polarization operation. Unlike the light absorption type polarization plate of the prior art, however, the rays of light that do not transmit the polarization film are not substantially absorbed by the polarization film. Therefore, the rays of light that are once reflected by the polarization film can be returned to the light source side and can travel again towards the reflection type polarization film by the reflection element disposed on the side of the light source such as the light diffusion film. Among the rays of light thus returned, only the light component in the vibration direction parallel to the transmission axis are transmitted and the rest are again reflected. Repetition of such transmission-reflection operations can increase the intensity of transmitted polarization light. A concrete example of such a reflection type polarization film is “DBEF Series” and “DRPF-H Series” (trade names), products of 3M Co. A circular polarization element may be used in place of such a linear polarization element. An example of the circular polarization element is a cholesteric type circular polarization element that is commercially available under the trade name “Nipocs” from Nitto Denko K. K.

The reflection type polarization film can be used at an arbitrary thickness, too, depending on the object of use. The thickness of the reflection type polarization film should be selected generally so as to reduce the size and the weight of the liquid crystal display device and is generally within the range of about 15 to 1,000 μm, preferably within the range of about 30 to 500 μm and further preferably within the rage of about 50 to 200 μm.

The optical films concretely described above and other optical films that are useful for the practice of the invention can be used in arbitrary shapes and arbitrary sizes in the same way as their thickness. For example, the optical film may have an arbitrary shape such as a circle, an ellipse, a polygon, and so forth but has generally and preferably a rectangular (square or rectangular) shape. The area of such an optical film includes a small area to a large area depending on the object of use of the optical film structure and is generally within the range of about 1 cm² to 2.0 m². In the practice of the invention, the film fixing system used in combination with the optical film exhibits its most effective operation when the area of the optical film is relatively large. In consequence, the occurrence of deformation and distortion of the film can be prevented while flatness of the film surface is kept. Therefore, it is recommended to use an optical film having a larger area. For example, the area of the optical film used in the invention in connection with a preferred screen size of a liquid crystal television unit is generally from about 15 to 20 inches or more. In the case of such a large-screen television unit, a perpendicular type backlight unit is generally used as its illumination unit. When the optical film structure is used on the backlight unit, disadvantages such as non-uniform diffusion of light, deformation and distortion of the film, etc, do not occur. The inventor of the invention has already confirmed that the optical film exhibits excellent effects in television units having a screen size of near 37 inches.

The use of the optical film will be explained further concretely. In the liquid crystal display device according to the invention, the polarization film can be arranged as the optical film on the light outgoing surface (light transmission surface) of the backlight illumination unit. The reflection type polarization film may be used in place of the polarization film. The reflection type polarization film is a linear polarization element such as a multi-layered reflective polarization film (for example, “DBEF Series” (trade name) and a single layered diffusion reflective polarization film (for example, “DRPF-H Series” (trade name). Needless to say, a customary beam deflection element such as the luminance improving film (for example, “BEF Series” (trade name) may be used in place of, or in combination with, such a linear polarization element, whenever necessary. In the liquid crystal display device according to the invention, the polarization film or the combination of the polarization film with the light deflection element is used for the backlight illumination apparatus and these films are fixed to the film fixing flame in accordance with the film fixing system of the invention. In consequence, the invention can provide a thin polarization light source that is excellent in light utilization efficiency and is free from the problem of film fixing. Alternatively, the polarization film may be a circular polarization element and may be a cholesteric circular polarization element that is commercially available from Nitto Denko K. K. under a trade name “Nipocs.

Specifically, the polarization films such as DBEF and DRPF-H transmit P polarization light and reflect S polarization light. While S polarization light so reflected repeats multiple reflections between the guide plate of the illumination unit and the light reflection element arranged adjacent to the guide plate and polarization is eliminated whenever S polarization light transmits through the diffusion plate. Consequently, a part of S polarization light is converted to P polarization light and is again utilized efficiently and transmits through the polarization film. When the multi-layered reflection film is used as the light reflection element accessorial to the guide plate during this multiple reflections, attenuation of light due to reflection can be made minimal and the polarization film can operate effectively.

DBEF and DRPF-H that have been used as the polarization films are not free from the problems of deformation caused by heat imparted to the films for some reason or other and non-uniformity of luminance resulting from the deformation of the films in the prior art technologies. However, when the film fixing system according to the invention is used, the problems of this kind can be avoided.

When DRPF-H and other polarization films are used in place of DBEF, a polarization light source emitting only P polarization light devoid of color non-uniformity and coloration can be provided because DRPF-H emits reflected light of a white color and has a single layered structure.

Preferably, the optical film explained above in detail is provided in the form of the optical film structure in combination with (1) the film fixing parts, (2) the film tension controlling member and (3) the film fixing frame. Such an optical film structure can be advantageously used as a member of the illumination apparatus for the liquid crystal display device and can fully exhibit its operation and effects.

The optical film structure according to the invention comprises:

at least one optical film described above;

at least four film fixing parts arranged respectively at outer peripheral portion of the optical film:

a film tension controlling member attached to each of the film fixing parts in such a fashion that one of the ends of the member is pullably attached under tension to the film fixing part while retaining flatness of the optical film; and

a film fixing frame for fixing the optical film, to which the other end of the film tension controlling member is connected.

In this optical film structure, the optical film, the film tension controlling member and the film fixing frame are preferably combined integrally with one another as one component.

The optical film structure according to the invention uses the film fixing parts as means for fixing the film to the film fixing frame. A necessary number of film fixing parts are generally fitted with caution to the outer peripheral portion of the optical film in such a fashion that the path of light of the optical film is not hindered. The number of fixing parts and their fitting positions are not particularly limited. However, at least four fixing parts are generally used and must be fitted to the four corners of the optical film. When the optical film becomes large in size, the number of film fixing members can be increased in such a fashion as to correspond to the increase of the size. When a large number of film fixing parts are used for each optical film, it is recommended to fit the film fixing parts at suitable positions of the optical film while the balance is taken into consideration so that the optical film can be brought into tension without inviting loosening and distortion in the resulting optical film structure.

The film fixing parts can be produced from various materials by means such as molding, casting and machining. Suitable examples of the materials for the film fixing parts, though not restrictive, include a resin material such as an acrylic resin, a metal material such as aluminum and stainless steel, and others. These film fixing parts can be used in various forms but the size is preferably as small as possible. Therefore, the film fixing member is preferably a small piece having a rectangular shape or other shape.

The film fixing parts may be fitted to one of the surfaces of the outer peripheral portion of the optical film. When gripping of the optical film and fitting of the film tension controlling member still remain unstable, the film fixing parts may be fitted to both surfaces of the optical film. Various fixing methods can be used for fitting the film fixing parts. An ordinary method uses an adhesive. An acrylic type adhesive or a urethane type adhesive each having a high bonding strength can be used. Means such as pressing, fitting, push-fitting, etc, can be used in place of, or in combination with, the adhesive. For example, U-shaped film fixing parts are prepared, the end portion of the optical film is inserted into the gap at the center and the film and the film fixing parts are then pressed as a whole to integrate the film fixing part with the optical film.

The film tension controlling member is further fitted to the film fixing parts fitted to the optical film. The film tension controlling member is generally a member elongated in a longitudinal direction and one of the ends of this member is fitted to each of the film fixing parts as described above. To fit such a film tension controlling member to the optical film (or to the film fixing parts fitted to the optical film), the optical film must be at least pulled under tension while its flatness is maintained. In case this step is omitted, the problems of warp and deformation of the optical film occur.

The film tension controlling member can be formed of various materials but is preferably formed of a flexible material. The film tension controlling member can use various flexible materials. Generally, however, viscoelastic wire materials such as a spring, a piano wire, rubber and other wire materials can be used advantageously. The film tension controlling member may be fitted either directly to the film fixing parts or indirectly through connection means such as a wire.

When the film tension controlling member having a wire shape is fitted to the film fixing parts, for example, a V-shaped groove into which the wire material can be fitted is defined in advance in the surface of the film fixing part and after the wire material is buried into the V-shaped groove, the film tension controlling member is fixed through the adhesive. Alternatively, the V-shaped groove side of the film fixing part is brought into contact with the optical film and both are bonded by the adhesive so that the film tension controlling member can be fixed more firmly to the film fixing pats.

It is also possible to arrange the piano wire to predetermined positions of the film fixing frame while a tension is applied by screw fixing, or like means. In this case, a wire fitted as connection means to the film fixing part is entangled and fixed. The piano wire portion applied with the tension can play the role of the film tension controlling member.

The other end of the film tension controlling member is connected to the film fixing frame with the result that the optical film is fixed to this film fixing frame. The film fixing frame is generally shaped in such a fashion as to encompass the outer peripheral portion of the optical film and can be formed of various materials. Suitable examples of the film fixing frame, though not restrictive, includes a resin material such as an acrylic resin or a polycarbonate resin, a metal material such as aluminum, stainless steel or steel, and so forth. A material that is light in weight is preferably used.

The film fixing frame preferably has sufficiently high mechanical strength in addition to its light weight. Therefore, to produce the film fixing frame, it is preferred to reduce as much as possible the thickness but to secure the strength. In other words, it is recommended to add a reinforcing member such as ribs to the film fixing frame or to employ a double-wall structure for the wall portion. The portions of the film fixing frame that are not believed to participate in the strength may be cut off, whenever necessary. An arbitrary method such as molding, casting, machining, or the like, may be used to form the film fixing frame. When the film fixing frame is formed of a metal material, for example, the metal material is bent and is cast to obtain a film fixing frame having a rigid structure. Only the fixing frame may be produced afresh and may then be assembled into the liquid crystal display device, and the frame portion of the casing for accommodating the light source portion of the liquid crystal display device can also be used as the fixing frame.

The film tension controlling member can be connected to the film fixing frame in accordance with various methods. For example, the piano wire can be fitted to the film fixing frame by welding, bonding, or the like, as described above. When the film tension controlling member is the screw or the spring, the member can be fitted to the film fixing fame by welding or screw fixing. It is further possible to form in advance a loop at the end of the film tension controlling member and to hook a pin or other protuberance formed in advance to the film fixing frame into the loop.

Preferably, the optical film structure according to the invention is used while arranged on the light transmission surface of the illumination unit essentially including at least one light source and the light transmission surface for guiding outside the rays of light from the light source. In this case, the invention provides the illumination apparatus. According to another aspect, the invention provides the liquid crystal display device when the optical film structure is used between the liquid crystal display unit and the illumination unit. The illumination unit of the illumination apparatus, the illumination unit of the liquid crystal display device and the liquid crystal display unit are not particularly limited, respectively. As will be understood from the following detailed explanation, the conventional illumination unit and the conventional liquid crystal display unit can be used either as such or after they are modified in an arbitrary way.

In the illumination apparatus according to the invention, the illumination unit includes at least one light source and the light transmission surface for guiding out the rays of light from the light source. Here, the illumination unit is preferably the edge light type backlight illumination unit or the perpendicular type backlight illumination unit. When the illumination apparatus is to be used for a large-screen liquid crystal display device of 20 inches or more, the perpendicular type backlight illumination unit is particularly preferable.

The edge light type backlight illumination unit preferably includes the following constituents, for example:

(1) at least one light source,

(2) a light guide element having one main surface for guiding out the rays of light incident through a side surface with substantially uniform luminance, having a light source arranged in the proximity of the side surface; and

(3) a light reflection element formed of an insulating material, so arranged as to encompass the light source and capable of introducing the rays of light from the light source into the side surface.

One or more light sources as the first constituent element may be disposed on only one of the side surfaces of the light guide element that is generally rectangular, as has ordinarily been employed in the illumination apparatus such as the backlight and front light apparatuses. Alternatively, one or more light sources may be disposed on the opposing side surfaces of the light guide element. The light sources may sometimes be disposed on all the four side surfaces of the light guide element.

In the practice of the invention, various kinds of light sources having various sizes and various shapes can be used. However, when the application of the illumination apparatus as illumination means of the display device such as the liquid crystal display device is taken into consideration, linear light sources such as a fluorescent lamp, particularly a cold cathode-ray tube or dot-like light sources such as a light emitting diode (LED) can be used advantageously. Particularly when the dot-like light source is used, a sufficient number of light sources are arranged in line on the side surface of the light guide element so as to accomplish desired luminance or rod-like light guide elements (for example, glass rods) are arranged on the side surface of the light guide element with the light sources being arranged at both end of the light guide element. Examples of usable light sources other than the cold cathode-ray tube and the LED include, though not restrictive, a hot cathode-ray tube and an electroluminescence (EL) device. Different kinds of light sources may also be used in combination, whenever necessary.

The light guide element as the second constituent element is generally rectangular and can be advantageously used in the form of a guide plate. The light guide element may be of a wedge type as has often been used in this field of technology and can be used as a wedge-shaped guide plate. When the wedge-shaped guide plate is used, the number of the light source may be only one and the guide plate is shaped in such a fashion that the thickness decreases form the side surface in the proximity of which the light source is set up towards the opposing side surface.

When the illumination apparatus according to the invention is used as the backlight in the reflection type or semi-transmission type liquid crystal display device, it is preferred to form a slope portion such as saw-tooth protuberances, steps or grooves on the light guide-out surface of the light guide element and to reflect the rays of light incident into the slope portion towards the other opposing surface (bottom surface).

Any materials can be used for the light guide element so long as they do not exert adverse influences on the light guide effect. When processability is taken into consideration, however, various plastic materials such as an acrylic resin, a polycarbonate resin, a polyolefin resin, an epoxy resin and a polystyrene resin can be used advantageously. Inorganic materials such as glass can be used in place of these plastic materials, whenever necessary.

The third constituent element is the light reflection element that is used while being so arranged as to encompass the light source. The light reflection element may have any shape so long as it can allow the rays of light from the light source to be efficiently incident into the side surface of the light guide element. When compactness and moldability are taken into consideration, however, the light reflection element preferably has a semi-cylindrical shape or a trough shape. Therefore, the light reflection element can be advantageously used in the form of a lamp reflector in the same way as in the prior art technologies. Incidentally, when forming the lamp reflector, it is advantageous to use a reflector film formed of an insulating material and not substantially containing a metal component without using an aluminum vacuum deposition film or a silver vacuum deposition film that has been used in the lamp reflector of the prior art. Because this reflector film has the insulating property, it is free from the problem of the prior art films in that the films pick up the leakage current from the light source, and because this film does not substantially lower luminance of the light source. The reflector film is preferably formed of an insulating material that can introduce the rays of light from the light source into the side surface of the light guide element with a reflection factor of at least 98%.

Preferably, the reflector film as the light reflection element is generally formed of a multilayered reflection film. The multilayered reflection film is a multilayered laminate film of polyethylene terephthalate (PEN) and its copolymer (coPEN) or a multilayered laminate film of PEN and syndiotactic polystyrene (sPS), for example. Such a multilayered reflection film may be used as such in a suitable shape when it has a self-supporting property. Alternatively, a suitable support shaped into the shape of the reflector is prepared and the reflector film may be bonded or stacked onto the inside of the support. Bonding or stacking of the multilayered reflection film may use an adhesive or a double-coated adhesive tape.

As described above, the illumination apparatus according to the invention can be advantageously used as the backlight in the liquid crystal display device and other display devices. Therefore, the illumination apparatus according to the invention preferably has the light reflection member formed of a multi-layered reflection material as the fourth constituent element.

When the illumination apparatus according to the invention is used as the backlight, the light reflection member is disposed preferably on the side surface of the light guide member other than the side surface having the light source in the proximity thereof, and further preferably on all the remaining three side surfaces and on the bottom surface of the light guide member. To distinguish this light reflection member from the light reflection element described above, it is particularly called the “light reflection member”. The light reflection member can be formed of an arbitrary material so long as the material can exhibit desired light reflection function. When the merit of excellent properties is taken into consideration, however, the light reflection member is preferably formed of the multi-layered reflection film in the same way as the light reflection element. Examples of the suitable multi-layered reflection film include a multi-layered laminate film of polyethylene terephthalate (PEN) and its copolymer (coPEN) or a multi-layered laminate film of PEN and syndiotactic polystyrene (sPS). To use the multi-layered reflection film, reference is to be had to the disclosure of Japanese National Publication (Kohyo) No. 9-511844.

In the illumination apparatus according to the invention, the light reflection element and the light reflection member are formed of the same material, preferably the multi-layered reflection film and moreover, integrally with each other. Such a construction makes it possible to render the apparatus compact, to reduce the number of components and to simplify the production. Moreover, the resulting strength can be improved. Particularly because the multi-layered reflection film need not be cut into small pieces in match with the shape of each part, handling becomes easy and procurement of components and the assembly work become also easy. Specifically, after one sheet of the multi-layered light reflection film is prepared and is cut finely into a predetermined shape, the light guide element is wrapped by the film to give the light reflection element and the light reflection member. Bonding of the light reflection member to the light guide element can be carried out by using the adhesive, the tackifier or the double-coated adhesive tape when the light reflection member does not by itself have the shape retaining property of a predetermined level. Bonding of the light reflection member can be carried out by applying an adhesive, tackifer or double-coated adhesive tape each being optically transparent, or in other words, each having a high transmission factor, to a part or the whole of the bonding surface of the light reflection member of the light guide element. To suppress the reflection on the bonding interface to a minimal level, bonding can be carried out by using an adhesive having a refractive index approximate to the refractive index of the light guide element. When the light guide element is an acrylic resin plate, for example, an acrylic type adhesive can be advantageously used.

In addition to the constituent elements described above, the illumination apparatus according to the invention may further optionally include one or more additional constituent elements. An example of suitable additional constituent element is a light diffusion layer. The light diffusion layer is disposed on the bottom surface of the light guide element, effectively promotes diffusion of light inside the light guide element and makes diffusion uniform. The light diffusion layer can be formed into various patterns (for example, a stripe pattern, a dot pattern, etc) from white paint containing organic or inorganic materials such as silica, barium sulfide, titanium oxide, glass bead, etc, as light diffusion particles. To form such a light diffusion layer, a printing method such as a screen printing method can be advantageously used.

The illumination apparatus according to the invention was described above about the edge light type backlight illumination unit as the typical example. Incidentally, the perpendicular type backlight illumination unit can be constituted fundamentally in the same way as the edge light type backlight illumination unit though the arrangement position of the light source is different. Therefore, the detailed explanation will be omitted herein.

The invention further provides a liquid crystal display device or other display devices having the feature in that an illumination apparatus is equipped with the backlight illumination unit according to the invention as a back surface light source.

The liquid crystal display device according to the invention may have any construction conventional in this field of technology. In the case of a transmission type liquid crystal display device, for example, the illumination apparatus according to the invention can be disposed as a back surface light source on the back surface of a liquid crystal panel having a structure in which a liquid crystal is sandwiched by polarization plates on both sides. In the case of a semi-transmission type liquid crystal display device, too, the illumination apparatus according to the invention can be disposed as the back surface light source on the back surface of the liquid crystal panel. The liquid crystal panel itself is not particularly limited in the invention and is well known to those skilled in the art. Therefore, the detailed explanation will be omitted herein.

The liquid crystal display device according to the invention can be advantageously used for display purposes in various household electric appliances, measuring instruments and other appliances. The application examples of the liquid crystal display device according to the invention, though they are not restrictive, include compact displays such as cellular phones, mobile information terminals, video cameras, digital cameras, etc to large-scale displays such as personal computers and television receivers. The function and effect of the invention can be most exhibited when used for large-scale displays having a display area of 20 to 30 inches or more in which deformation and distortion of the optical film are likely to occur.

The illumination apparatus according to the invention can exhibit its excellent function and effect in fields other than the liquid crystal display device. When a photograph or a printed matter is arranged below the illumination apparatus in place of the liquid crystal panel, the illumination apparatus can be used advantageously as the front light apparatus. The illumination apparatus according to the invention can be utilized as the light source of an overhead projector (OHP) by modifying its design. Furthermore, the illumination apparatus of the invention can be utilized as a light monitor of various measuring instruments and monitors.

### EXAMPLES

As described above, the invention can be advantageously carried out in various embodiments. Subsequently, several examples of the invention will be explained with reference to the accompanying drawings. It is to be understood, however, that the invention is not limited by the following examples.

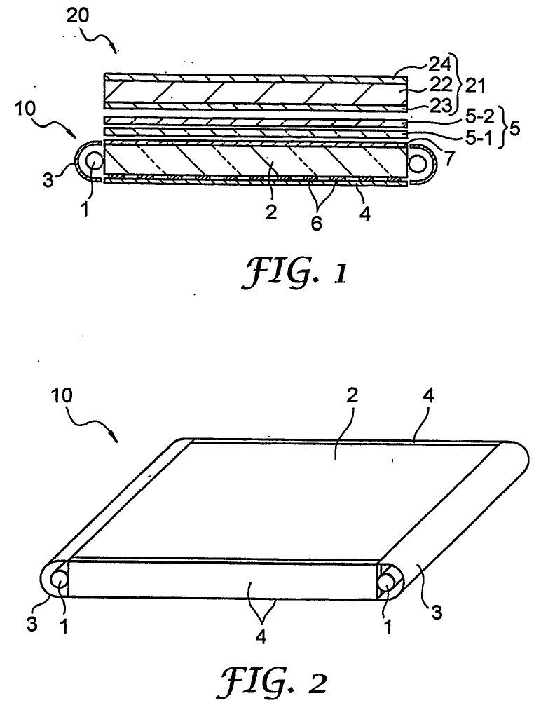

FIG. 1 is a sectional view schematically showing a transmission type liquid crystal display device according to an embodiment of the invention and FIG. 2 is a perspective view of a backlight illumination unit used as a back surface light source in the liquid crystal display device shown in FIG. 1.

As shown in FIG. 1, the liquid crystal display device 20 has a liquid crystal panel 21 including a liquid crystal cell 22 and polarization plates 23 and 24 sandwiching from above and below the liquid crystal cell 22. An illumination apparatus of the invention comprising a backlight illumination unit 10 disposed on the side of a non-display surface of the liquid crystal panel 21 and an optical film structure inclusive of an optical film 5 and arranged on the backlight illumination unit 10 is provided to the liquid crystal display device 20. The optical film 5 includes a light diffusion film 5-1 at a lower part and a luminance improving film 5-2 at an upper part. The optical film 5 constitutes the optical film structure in combination with film fixing parts, a film tension controlling member and a film fixing frame that are not shown in the drawings. The optical film 5 is fixed under tension to the film fixing frame and is further fixed to a casing of the backlight illumination unit 10. The backlight illumination unit 10 has a diffusion plate 7 on its light transmission surface. Since the construction of the liquid crystal panel 21 is well known from a number of references, its detailed explanation will be hereby omitted.

As shown in FIG. 2, the backlight illumination unit 10 includes a rectangular light guide plate 2, light sources 1 arranged in the proximity of the opposing side surfaces of the polarization plate 2, lamp reflectors 3 so arranged as to encompass the light sources 1, respectively, and multi-layered reflection films 4 arranged on the side surfaces of the conductor plate 2 not having the light source (two opposing side surfaces) and on the lower surface. The rectangular plate 2 has a light diffusion layer 5 arranged in a dot form on the entire bottom surface.

In the backlight illumination unit 10 shown in the drawing, the rectangular light guide plate 2 is formed of an acrylic resin plate as is ordinary in this field of technology. The light sources 1 arranged on the two side surfaces of the light guide plate 2 are cold cathode-ray tubes as a kind of fluorescent tubes and have an almost equal length to the side surfaces. The lamp reflector 3 encompassing each light source 1 is a reflector film formed of an insulating material having high light reflection property of 98% or more, concretely a multi-layered reflection film. The reflector film is bonded by an adhesive to the inner surface of a support having a corresponding shape. The same multi-layered reflection film 4 as the one used for the lamp reflector 3 is fitted to the remaining side surface of the light guide plate 2. However, the support is not used herein and the film is directly bonded by use of a transparent adhesive. The adhesive is applied to the entire surface of the multi-layered reflection film but depending on cases, the adhesive may be applied to a part of the surfaces or a double-coated adhesive tape may be used in place of the adhesive.

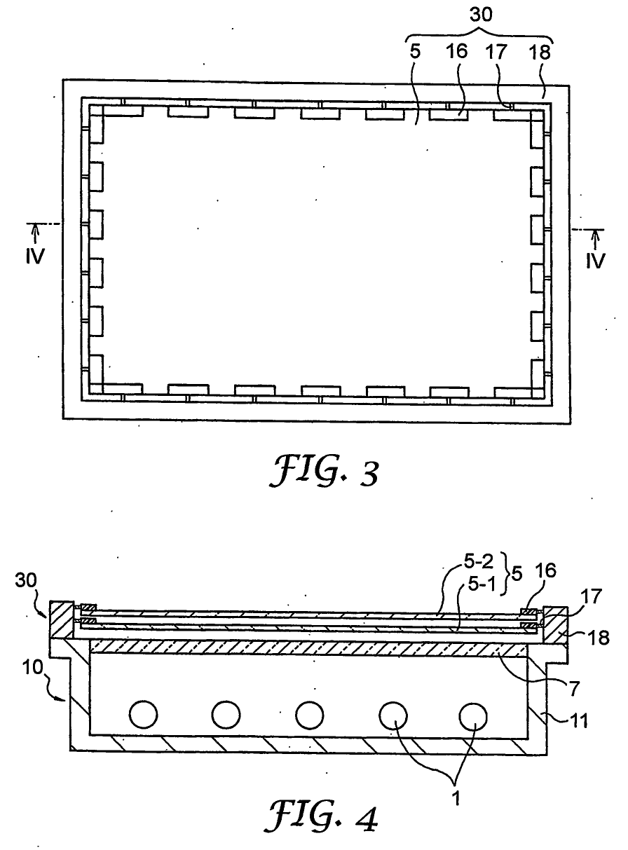

FIG. 3 is a plan view showing an illumination apparatus according to a preferred embodiment of the invention and FIG. 4 is a sectional view taken along a line IV-IV of the illumination apparatus shown in FIG. 3. As can be understood from these drawings, the illumination apparatus of the invention includes a perpendicular type backlight illumination unit having a plurality of light sources 1 arranged on an aluminum die-cast casing 11 and an optical film structure 30 of the invention disposed on the backlight illumination unit 10. The perpendicular type backlight illumination unit 10 includes a light diffusion plate 7 for allowing the rays of light from the light sources to uniformly outgo outside the illumination unit. A liquid crystal display unit, not shown, is further disposed on the optical film structure 30 as explained previously with reference to FIG. 1.

The perpendicular backlight illumination unit 10 is a schematically illustrated example. An actual backlight illumination unit can have constituent elements other than those shown in the drawings or constructions other than that shown in the drawings. For example, the light source 1 can have various forms as explained in the paragraph of the edge light type backlight illumination unit. The casing 11 uses the casing formed by die casting aluminum from the aspects of strength and moldability but may be formed of other metal materials and resin materials. The shape of the casing 11 can be changed arbitrarily in consideration of the improvement of the strength. The wall portion may have a double-wall structure or ribs may be fitted to the wall as modified examples of the casing.

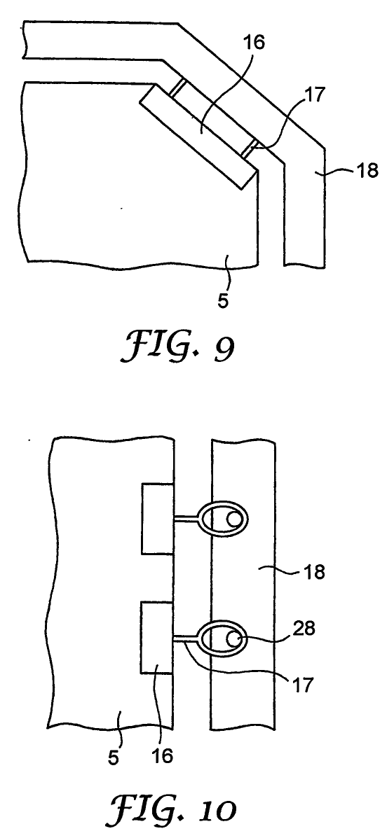

In the case of the illustrated example, the optical film structure 30 has an optical film 5 having a two-layered structure of a lower light diffusion film 5-1 and an upper luminance improving film 5-2. The gap between the two films is about 0.8 mm. Film fixing parts are fitted to the outer peripheral portion of each optical film. In the illustrated example, twenty-six in total of film fixing parts are fitted to suppress distortion of the optical film and to secure firm fixing. The film fixing parts may be fitted to only the four corners of the optical film when a sufficient effect can be obtained as will be hereinafter explained with reference to FIG. 9.

The film fixing parts 16 are not particularly limited and may be formed of a resin material or a metal material such as aluminum into an arbitrary shape. In the case of the illustrated example, the film fixing part 16 is formed of a resin plate having a V-shaped groove of a depth of about 0.3 mm at the center of one of its surfaces and a thickness of about 0.5 mm, fitting a wire 17 constituting a part of the film tension controlling member into the V-shaped groove and fixing the film fixing part to the optical film 5 through the adhesive (not shown).

When a metal plate (for example, an aluminum plate) is used as the film fixing part, the film fixing parts 26 can be fixed as shown in FIG. 6. First, to use as a film fixing part, a 0.5 mm-thick aluminum plate having a V-shaped groove of a depth of about 0.3 mm at the center of one the surfaces is first prepared. After the wire 17 constituting a part of the film tension controlling member is disposed in the V-shaped groove, the wire 17 and the film fixing member 26 are fixed by the adhesive 19. Next, the surface of the aluminum plate opposite to the surface having the V-shaped groove and the optical film 5 are bonded through the adhesive.

The film tension controlling member 17 fitted to the film fixing part 16 is for pulling the optical film 5 under tension while maintaining its flatness. Therefore, the remaining portion of the film tension controlling member 17, generally the flexible member having the film tension controlling mechanism, is contained inside the film fixing frame 18 though it is not shown in FIG. 4. Examples of the flexible member are a flexible component such as a spring and a resin component having viscoelasticity such as rubber. The flexible member of the film tension controlling member 17 may be connected either directly to the film fixing parts 16 or 26 or connection means such as a wire may be further disposed between the flexible member and the film fixing part.

The distal end of the film tension controlling member 17 is connected to the film fixing frame 18, so that the optical film can be fixed stably. Though not particularly limited, the film fixing frame 18 is preferably formed of the material that is as light in weight as possible and excellent in strength. The shape of the film fixing frame 18 can be arbitrarily changed, too. It is generally preferred to shape the film fixing frame 18 from a metal material such as aluminum or stainless steel through bending and casting step to provide a rigid structure. The shape of the film fixing frame 18 is preferably a box shape or a frame shape formed by removing unnecessary wall surfaces from the box shape. The film fixing frame 18 is generally fitted to the casing 11 of the backlight illumination unit 10 but may be fitted to other members, whenever necessary.

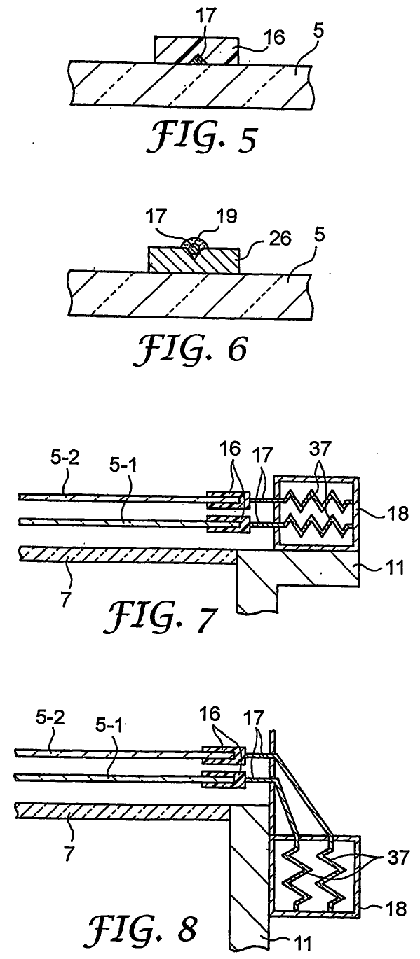

The examples shown in FIGS. 3 to 5 employ the method that fixes the film fixing parts 16 to one of the surfaces of each of the optical films 5-1 and 5-2. However, it is also possible to employ the method that fixes the film fixing parts 16 to both surfaces of the optical films 5-1 and 5-2 so as to firmly fix the film fixing parts 16 to the optical films as shown in FIGS. 7 and 8. The illustrated examples employ the method that prepares the bracket-shaped film fixing parts 16, inserts the end of the optical film into the gap and fix the optical film. Needles to say, two film fixing parts may be butted against each other and may then be bonded to each other through the adhesive without using the U-shaped film fixing parts. In the example shown in FIG. 8, in particular, the film fixing frame 18 is disposed on the side surface of the casing 11 of the backlight illumination unit. Therefore, this construction can satisfy the recent requirement that the width of the frame of the display screen is preferably as small as possible (generally from about 3 to 4 mm).

As can be understood from FIGS. 7 and 8, the flexible member (spring) 37 of the film tension controlling member 17 is accommodated in a box-shaped film fixing frame 18 and its ends are fixed. Further, the flexible member 37 is interconnected to the film fixing part 16 through the wire 17.

The optical film structure 30 shown in FIG. 3 represents the optical film 5 having the twenty-six in total of film fixing parts. However, the film fixing parts 16 may be fitted to only the four corners of the optical film 5 as shown in FIG. 9 provided that the optical film can be fixed stably to the film fixing frame 18 without inviting deformation and distortion. In the case of the illustrated optical film structure, two film tension controlling members 17 are fixed to one film fixing part 16 and the distal end of each film tension controlling member 17 is fitted to the film fixing frame 18.

In the practice of the invention, fitting of the film tension controlling members 17 to the film fixing frame 18 may be carried out by various means.

As shown in FIG. 10, for example, a wire equipped at one of its ends with a loop that has a film tension controlling mechanism is prepared as the film tension controlling member 17. One of the ends of this film tension controlling member 17 is fixed to the film fixing part 16 provided to the outer edge of the optical film 5. The loop as the other end of the film tension controlling member 17 is hooked to a pin 28 provided onto the film fixing frame 18. The film tension controlling member 17 is flexibly movable due to the existence of the loop.

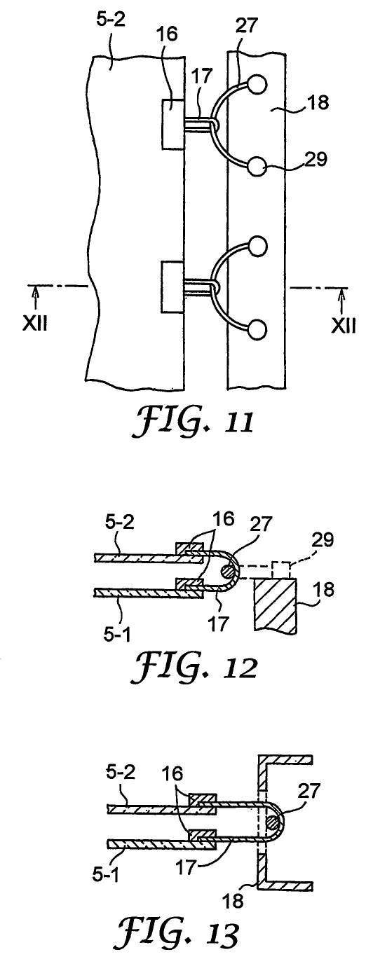

Alternatively, the film tension controlling member 17 can be fitted to the film fixing frame 18 as shown in FIGS. 11 and 12 (sectional view taken along a line XII-XII in FIG. 11). In the illustrated example, a hook member (piano wire).27 is fixed to the film fixing frame 18 through a screw 29 and the wire 17 is fixed to the center portion of the piano wire 27. In this case, the portion of the piano wire 27 to which the tension is applied plays the role of the flexible member.

Further, the piano wire 27 as the flexible member can be fitted in a bridge form to an open portion formed in the side surface of the film fixing frame 18 as shown in FIG. 13. Since the film fixing frame 18 is formed of a metal material such as steel, the piano wire 27 can be firmly fixed by welding, or the like.

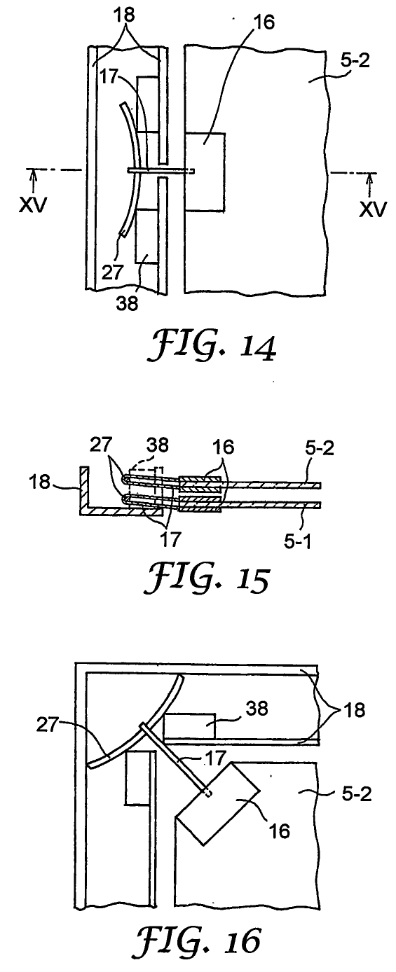

The film tension controlling member 17 can be fitted to the film fixing frame 18 in the manner shown in FIG. 14, FIG. 15 (sectional view taken along a line XV-XV in FIG. 14) and FIG. 16.

In the example shown in the drawings, two film fixing parts (aluminum plates) 16 are so bonded to the peripheral portion as to face each other in each of the optical films 5-1 and 5-2 and the distal end of the wire 17 constituting a part of the film tension controlling member is fitted into the V-shaped groove (not shown) of each aluminum plate 16 and is bonded through the adhesive. The wire 17 is first passed through the slit of the film fixing frame 18 formed of an aluminum frame the upper part of which is open, and is then hooked to a hook member (piano wire) 27 anchored to a seat 38 inside the film fixing frame 18. Because the piano wire 27 is movably supported by the groove (not shown) of the seat 38, the wire 17 functions as a flexible member capable of coping with extension and contraction of the optical film.

FIG. 16 shows the fitting state of the film tension controlling member 17 at a corner of the film fixing frame 18. The film tension controlling member 17 can be fitted at the corner, too in the same way as the linear portion shown in FIGS. 14 and 15.

When the piano wire and the wire are combined to constitute the film tension controlling member as described above, an excellent tension controlling function can be acquired and even when slight extension and contraction of the optical film exists, the film tension controlling member operates effectively in such a fashion as to supplement the extension and contraction and prevents the occurrence of even slight deformation and distortion in the optical film.

As explained above in detail, the invention includes at least one, preferably two or more, optical films and can use each optical film under the thin film state. Therefore, the invention can reduce the weight and can moreover maintain flatness of the optical films. In consequence, the invention can provide an optical film structure useful in a liquid crystal display device and other display devices without inviting warp and distortion.

The invention can also provide an illumination apparatus having such an excellent optical film structure and useful in a liquid crystal display device and other display devices.

The invention can further provide a liquid crystal display device that is excellent in display performance associated with illumination, can reduce the weight, does not need to separately use the film thickness of the optical films in accordance with the size of the apparatus, can reduce the number of components and can simplify the assembly operation of the components during the production of the apparatus.

In addition to the remarkable effects described above, the invention provides the following effects in the liquid crystal display device, for example:

Films having a high luminance improving effect that have not been usable in large liquid crystal display devices can be used, and a film structure having a higher luminance improving effect can be accomplished;

Films having a high luminance improving effect that have been used separately for large-scale and medium-scale liquid crystal display devices can now be used irrespective of the size and consequently, a film structure (combination of optical films) having higher freedom can be provided;

Diffusion layers free from distortion can be provided for all sizes by using a light diffusion film in place of an acrylic diffusion plate and the weight can be reduced, too; and

Because a plurality of optical films can be integrated, subsequent fabrication steps can be simplified and rendered more efficient and a protective film can be eliminated.

What is claimed is:

1. An optical film structure disposed on a light transmission surface of an illumination unit, for modulating light emitted from said illumination unit and projecting modulated light, comprising:
at least one optical film;
at least four optical film fixing parts disposed at an outer peripheral portion of said optical film;
a film tension controlling member attached at one of the ends thereof to each of said film fixing parts in such a fashion as to be capable of pulling said optical film under tension while maintaining flatness of said optical film; and
a film fixing frame for fixing said optical film, connected to the other end of said film tension controlling member;
wherein said optical film, said film tension controlling member and said film fixing frame are integrated with one another and are constituted into one component.

2. An optical film structure as defined in claim 1, wherein said optical film is a member selected from the group consisting of a light diffusion film, a light reflection film, a luminance improving film, a polarization film and a multifunctional optical film having at least two performances of said films.

3. An optical film structure as defined in claim 1 or 2, wherein said film tension controlling member is formed of an elastic material.

4. An optical film structure as defined in claim 3, wherein said elastic material is a spring or rubber.

5. An optical film structure as defined in any one of claims 1 to 4, wherein said at least two of said optical films are stacked with or without a gap between them.

6. An optical film structure as defined in any one of claims 1 to 5, which is used between a liquid crystal display unit and an illumination unit in a liquid crystal display device.

7. An illumination apparatus comprising:
an illumination unit at least including at least one light source and a light transmission surface for guiding outward the rays of light from said light source; and
an optical film structure as defined in any one of claims 1 to 5 that is arranged on said light transmission surface of said illumination unit.

8. An illumination apparatus as defined in claim 7, which is used as a backlight illumination unit on the back surface of a liquid crystal display device.

9. A liquid crystal display device comprising:
an illumination unit at least including at least one light source and a light transmission surface for guiding outward the rays of light from said light source;
an optical film structure as defined in any one of claims 1 to 5 that is arranged on said light transmission surface of said illumination unit; and
a liquid crystal display unit arranged on said optical film structure.

10. A liquid crystal display device as defined in claim 9, wherein said illumination unit is a backlight illumination unit.
